(19) United States
(12) Patent Application Publication
(10) Pub. No.: US 2008/0011500 A1
(43) Pub. Date: Jan. 17, 2008

(54) Lightning grounding towers as used in sytems for inducing lightning to eliminate hurricanes

(76) Inventor: Robert W. Beckwith, Clearwater, IL (US)

Correspondence Address: Leo J. Aubel, 111 Rivershire Lane, Lincolnshire, IL, 60069, US

(21) Appl. No.: 11/714,559

(22) Filed: Mar. 6, 2007

Related U.S. Application Data
(63) Continuation-in-part of application No. 11/485,916, filed on Jul. 13, 2006.

(51) Int. Cl. H02G 13/00

(52) U.S. Cl. 174/3

(57) ABSTRACT

It is believed that Raytheon uses lightning strikes to prevent rotating clouds from building into hurricanes. In this invention, metal towers are placed on islands so as to safely ground the Raytheon man made lightning strokes without damage to property or loss of life.

Heat lightning is high in the sky, going from cloud to cloud with little of no sound.

Type 1 lightning consists of a number of strokes forming between electric charges in clouds connecting to one of many leader strokes coming up from the ground. Each stroke of lightning forms in a series of high speed ionized arcs between electron sources and electron holes. When the last arc forms the lightning current has nanosecond rise times causing rather strange behavior.

Type 2 lightning consists of a single stroke made up of electron holes flowing up from the ground to a source of electrons in the sky. Type 2 lightning causes a very loud bang easily distinguished from other forms of lightning. Man made type 2 lightning is used in preventing the formation of hurricanes.

The High Altitude Aural Research Project (HAARP) is made up of as many as 100 high power radio frequency transmitting stations stretching from the furthest point North to the furthest point south in the state of Alaska. A control system permits the formation of balls of water and energy and accurately delivering and releasing such balls over large distances from the transmitting stations.

### SUMMARY

It is believed that the Raytheon corporation (Raytheon) has been using the HAARP system to deliver balls of electrons, each capable of causing a Type 2 lightning strokes in patterns that prevent rotating clouds from developing into hurricanes. It is known that there have been no major hurricanes in the Gulf of Mexico since mid 2006. We believe that credit goes to Raytheon for this remarkable accomplishment.

While it is believed that Raytheon positions each strike with the accuracy of the GPS system, there may be consequential damage ane even loss of life due to the lack of precise knowledge of the point each stroke goes to ground. The present invention offers a carefully designed and installed grounding tower network for assuring safe grounding of each and every man made lightning strike generated by Raytheon. With such safety assured, Raytheon and others could go public and convince the insurance industry to greatly reduce the cost of hurricane and flood insurance.

### FIGURES

FIG. 1 A metal tower for conducting lightning strokes safely to ground.

FIG. 2 A map of Cuba showing locations for placing metal towers to prevent damage or loss of life from use of the HAARP system.

FIG. 3 A map showing islands for placing metal towers in areas where rotating clouds are known to frequently be found.

### THE EMBODIMENT OF THE INVENTION

It is believed that Raytheon uses the HAARP system to form balls of electric energy in the form of balls of electrons and teleports these balls to points where man made type 2 lightning takes energy out of rotating clouds before the clouds can build to damaging and even hurricane force. Raytheon has successfully prevented hurricane formation since the fall of year 2006. Raytheon has not, however, been able to eliminate consequential damage and perhaps even loss of life as the man made lightning strikes the ground. The present invention proposes the addition of metal grounding towers to safely ground each and every man made lightning stroke.

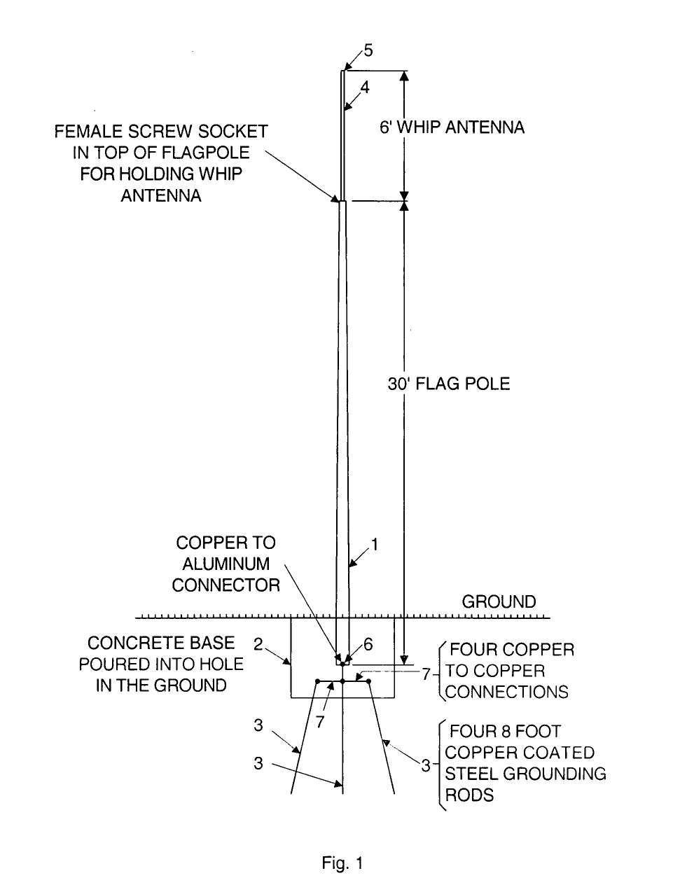

FIG. 1 shows the metal tower using a commercially available 30′ tapered aluminum flagpole 1 supported by poured concrete base 2. Grounding conductors consisting of four 8 ft copper coated steel grounding rods 3 driven into the ground to minimize the rise in ground potential under the tower during a man made lightning stroke to the tower.

A standard whip antenna 4 is fastened to the top of the flagpole 1 with any ball on the end removed. A female socket with threads matching those on the whip antenna is used for convenient fastening the flag pole and whip antenna together both mechanically and electrically. This leaves a relatively sharp upper point 5 on the whip antenna for ionizing the air as the man made lightning strikes the tower.

All four copper coated steel grounding rods 3 are connected together with four copper to copper connections 7. A copper to aluminum 6 connects the four copper coated rods to the flagpole 1. After all connections have been made and the flagpole temporarily held in place, concrete is poured into a hole in the ground approximately 2 ft square by 2 ft deep. When hardened the concrete protects all above connections and further binds the tower and ground rods together into a structure capable of withstanding high winds.

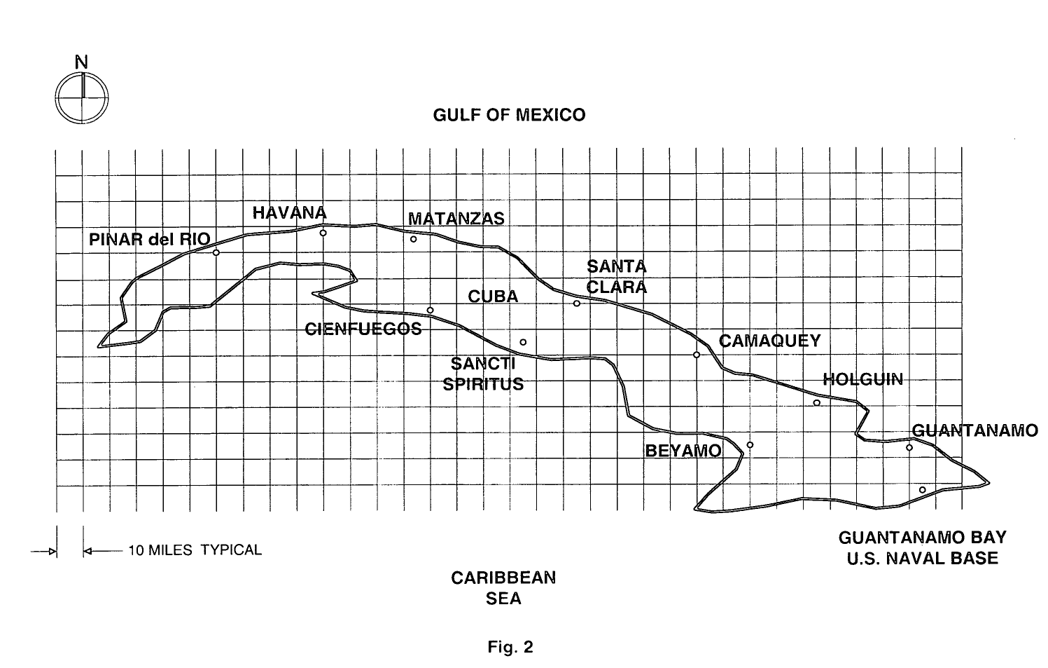

FIG. 2 shows a map of Cuba with a 10×10 mile grid overlaid. Cuba is of particular interest since this is the last zone of defense for storms originating south of Cuba and moving upward. Cuba is protected from hurricanes with the Raytheon hurricane prevention system.

Raytheon surely uses GPS accuracy in applying lightning to prevent the formation of hurricanes. The selected man made lightning strike points need only be shifted by Raytheon to the nearest intersection of the Grid for safely carrying strokes over a metal tower to ground. The number in intersections shown in FIG. 5 yields something less that 100 useable tower location points in Cuba. This number of points can be increased by a factor of 10, however, with the use of a 5×5 mile grid.

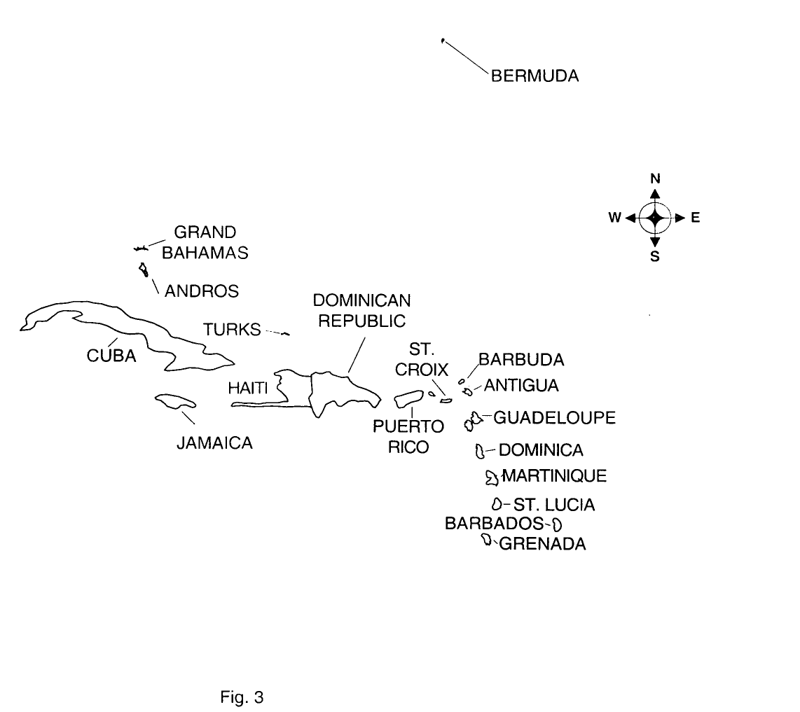

FIG. 3 shows a map of the Carribean requiring towers on most, if not all islands shown. Metal towers are installed on islands over this area using the location techniques described under FIG. 2.

### ADVANTAGES OF THE INVENTION

1. Providing Raytheon safe grounding points for their man made lightning strokes.
2 Going public with the news that the outstanding Raytheon performance in eliminating hurricanes could eliminate the insurance companies need to financially prepare for another Kartina. It should be possible to greatly reduce the cost of hurricane and flood insurance.

1. The method of using metal tower means for safely grounding lightning strokes used in preventing hurricanes from forming,

2. A method as in claim 1 further including combinations of flagpoles and whip antennae means for constructing said metal towers,

3. A method as in claim 1 further including copper clad steel rod means for grounding said metal towers,

4. A method as in claim 1 further using poured concrete means for supporting said metal towers,

5. A method as in claim 5 further including connection means for connecting said towers and said copper clad steel rods, and

6. A method as in claim 6 further including protection means for said connections by placing them within said poured concrete supports.
